(19) United States
(12) Patent Application Publication
(10) Pub. No.: US 2023/0156314 A1
(43) Pub. Date: May 18, 2023

(54) GAZE-BASED CAMERA AUTO-CAPTURE

(71) Applicant: Meta Platforms Technologies, LLC, Menlo Park, CA (US)

(72) Inventors: Sebastian Sztuk, Virum (DK); Salvael Ortega Estrada, Cedar Park, TX (US); Sapna Shroff, Burlingame, CA (US); Jun Hu, San Jose, CA (US); Yilei Li, Fremont, CA (US)

(21) Appl. No.: 18/053,280

(22) Filed: Nov. 7, 2022

Related U.S. Application Data
(60) Provisional application No. 63/279,514, filed on Nov. 15, 2021.
(60) Provisional application No. 63/348,889, filed on Jun. 3, 2022.

(51) Int. Cl. H04N 5/232; G06F 3/01; G02B 27/00; G02B 27/01

(52) U.S. Cl. CPC H04N 5/23219; G02B 27/017; G02B 27/0093; G02B 27/0101; G06F 3/013; H04N 5/23296; H04N 5/232127; G02B 2027/014; G02B 2027/0138

(57) ABSTRACT

A method for capturing a scene in a virtual environment for an immersive reality application running in a headset is provided. The method includes determining initiation of an auto-capture session in a headset by a user, the headset running an immersive reality application hosted by a remote server, executing a gaze model based on the initiation, detecting through the gaze model a gaze of the user, tracking the gaze of the user, capturing a scene in a virtual environment based on the gaze of the user, and storing the scene as a media file in storage. A headset and a memory storing instructions to cause the headset and a remote server to perform the above method are also provided.

### CROSS-REFERENCE TO RELATED APPLICATION

The present application is related and claims priority under 35 USC §119(e) to U.S. Provisional Pat. Applications No. 63/279,514, filed Nov. 15, 2021, and 63/348,889, filed Jun. 3, 2022, both to Sebastian Sztuk et al., both entitled GAZE-BASED CAMERA AUTO-CAPTURE, the contents of which are incorporated herein by reference in their entirety, for all purposes.

### BACKGROUND

### Technical Field

The present disclosure generally relates to augmented reality/virtual reality (AR/VR) and, more particularly, to a gaze-based auto-capture system.

### Related Art

Virtual reality (VR) includes simulated experiences that may be similar to, or completely different from, the real world. Applications of virtual reality include entertainment (e.g., video games), education (e.g., medical or military training), and business (e.g., virtual meetings). Other distinct types of VR-style technology include augmented reality and mixed reality, sometimes referred to as extended reality.

Augmented reality (AR) is a type of virtual reality technology that blends what the user sees in their real surroundings with digital content generated by computer software. The additional software-generated images with the virtual scene typically enhance how the real surroundings look in some way.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a network architecture where a user of a VR/AR headset performs a video capture of an immersive reality view triggered by a user gaze, according to some embodiments.

FIG. 2 illustrates a system configured for gaze-based camera auto-capture, in accordance with one or more implementations.

FIG. 3A is a wire diagram of a virtual reality head-mounted display (HMD), in accordance with one or more implementations.

FIG. 3B is a wire diagram of a mixed reality HMD system which includes a mixed reality HMD and a core processing component, in accordance with one or more implementations.

FIG. 4 illustrates screenshots of a privacy wizard from a social-network application running in a VR/AR headset, according to some embodiments.

FIG. 5 illustrates a social graph used by a social network to manage privacy settings in messaging and immersive reality applications upon user request, according to some embodiments.

FIG. 6 illustrates an example flow diagram for gaze-based camera auto-capture, according to certain aspects of the disclosure.

FIG. 7 illustrates an example flow diagram for gaze-based camera auto-capture, according to certain aspects of the disclosure.

FIG. 8 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure. Components having the same or similar reference numerals are associated with the same or similar features, unless explicitly stated otherwise.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included claims. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

### General Overview

Virtual reality (VR) includes simulated experiences that may be similar to, or completely different from, the real world. Applications of virtual reality include entertainment (e.g., video games), education (e.g., medical or military training), and business (e.g., virtual meetings). Other distinct types of VR-style technology include augmented reality and mixed reality (e.g., extended reality).

Augmented reality (AR) is an interactive experience that combines the real word and computer-generated content. The content can span multiple sensory modalities, including visual, auditory, haptic, somatosensory, and even olfactory. AR systems combine real and virtual worlds, in real time, and provide an accurate registration of three-dimensional (3D) objects.

Mixed reality (MR) is the merging of a real-world environments and a computer-generated environment. In MR, physical and virtual objects may coexist in mixed reality environments and interact in real time.

According to aspects, systems, methods, and computer-readable media may utilize gaze tracking information to inform an auto-capture system to perform a capture (e.g., of a scene).

According to aspects, in order to enable a good auto-capture experience, gaze input from an AR/VR device, such as smart glasses or other similar devices, along with other data such as point-of-view camera image, video, AI data (e.g., such as a face and/or smile detection alert), location data, audio data (e.g., such as laughter, etc.), inertial measurement unit (IMU) data (e.g., such as gyro/accelerometer data indicating user’s motion status, etc.), may be utilized. Electroencephalogram (EEG) and/or (EMG) electromyography data may also be utilized.

According to aspects, the smart glasses may include an eye/gaze tracking system for auto-capturing a scene and/or for other use cases such as display correction. For example, an auto-capture experience may be based on attention from the user, which is captured by a gaze/eye tracking system on the AR glasses.

According to aspects, a camera of a device (e.g., an AR/VR device) may capture an image/video when it is determined that a user is heavily engaged with content. The image/video that was captured may also be framed by cropping and zooming the captured content. In some embodiments, gaze information retrieved from the user can be used for video stabilization. The scene and intent of the user may be understood by utilizing camera/depth/audio/IMU cues.

According to aspects, a gaze-based attention signal may be sent from the device to an application to be used in an auto-capture algorithm (e.g., capture process). In an implementation, the eye-tracking may further provide information about an object-of-interest from the user (e.g., especially in the case of a moving object), which in turn can assist smart auto-focus or auto-zoom algorithms to focus on/zoom in to, the object of interest. This could control the auto-focus mechanism of a camera module, and control post processing of focus blur in the image.

According to aspects, a user may initiate an auto-capture session (e.g., a time-constrained session). For example, by having the user explicitly start the auto-capture session, the system may avoid capturing an unwanted scene when a user gazes at it but does not intend to capture it. In such cases, the auto-capture session will not begin until the user has initiated it. It is understood that the system may also be fully automated for auto-capturing.

According to aspects, the system runs a gaze model in the background. For example, the gaze model may detect that the user is gazing at something longer than threshold, and in response, may start a next level of a confirmation model that uses machine learning to understand what is in the cameras FOV, and what the user is looking at/interacting with (e.g., a CV confirmation model). In an implementation, the CV confirmation model confirms that there is a meaningful object in the user’s view (i.e., a car, a person, an object of art, or an item for purchase), and starts capturing an image/a video automatically. Eye tracking can track what the user is looking at during capturing and may further perform auto-focus/auto-zooming for the object that the user is looking at.

According to additional aspects, the gaze signal from the smart glass may be utilized as a trigger to start the auto-capture session. For example, the gaze detection runs in the background, and when the user gazes at something long enough, the eye gaze detection detects the user’s attention (and combined with other contextual signals, such as user location is in an amusement park). The system may prompt the user (e.g., with a query) asking whether to begin an auto-capture session. For example, the query may ask, “Seems like something interesting is happening - shall I start an auto-capture session?” The user may then confirm to begin the auto-capture session. For example, the user may confirm through voice assistance, a gesture, or approval on the companion phone/watch/EMG wrist band/photoplethysmogram (PPG).

As an example, a user may be attending a party (e.g., birthday party, holiday party, etc.). The user may initiate an auto-capture session through a point-of-view (POV) camera. In an implementation, an initiation mode may be utilized to understand if the auto-capture should start or not. For example, a low resolution and/or low power mode may begin and periodically detect faces, smiles, etc. The initiation mode may also detect written birthday signs, a cake, a Christmas tree, present boxes, etc. The initiation mode of the auto-capture session may also detect audio signals, such as laughter and singing (e.g., the birthday song, a holiday song, etc.). For example, the detected audio may include “Ho Ho Ho,” which may inform the auto-capture session that the user is at a holiday event (e.g., Christmas). In an aspect, the eye gaze tracker is triggered when one or more of the above are detected simultaneously. For example, the eye tracker may also provide a gaze direction of the user. According to aspects, multiple people in a room are wearing AR/VR glasses and gazing at the same object, such that the auto-capture session may start once signals from the multiple users engaged with the same event/object are received.

According to aspects, a full capture such as a 30 second video, or a single frame picture or photo may be triggered to be captured. The captured video may have a field-of-view (FOV) centered on the eye gaze for maximizing media resolution and optimizing content framing.

According to additional aspects, blinks (intentional or not) may be noted by the eye tracker and may be utilized to trigger high resolution snapshots and/or burst shots, or may be indicative of a user’s fatigue. These may also be triggered along with simultaneous video capture. In an implementation, the system may go back in time to look at what frame the blink happened and go further back (e.g., another 0.5 s) in time from when the blink was intended by the user (e.g., when the blink happens and is detected, the event already happened, but the video stream may be included in a buffer). Eye gaze data may be saved as metadata along with image and/or video. This may be used to identify the main subject of interest in post-processing.

After a completed auto-capture session, a montage may automatically be put together by selecting time segments of videos, most relevant stills, framing and/or cropping them, and putting them together in a slideshow or collage/montage-video as the “most valuable moments” that is then presented to the user to review before posting on social media. In an implementation, this may be accomplished by leveraging an AI algorithm that uses gaze data and one or more of the following data: video, still, face, smile, audio, laughter, IMU, motion, etc. The listed data may be collectively utilized to interpret interest for the user. In an implementation, the system may utilize eye gaze data and the user’s face data for the trigger.

According to additional aspects, the system may utilize the user eye gaze in combination with heart rate data (e.g., from a wearable device/wristband, etc.) and other additional data. For example, an auto-capture session may be based on data from an electromyography (EMG) wrist band or mounted on the smart glass itself. The user’s blood pressure, EMG, and whether the user’s pulse is rising (HRM), e.g., from a photoplethysmography (PPG) sensor. Some embodiments may also include electro-encephalography (EEG) sensors mounted on the smart glass to detect brain and neural system activity.

According to additional aspects, the system may leverage signals from multiple sensors, such as an eye tracking camera, pulse sensor, blood sensor, EMG sensor, etc. In an implementation, a relation model may be built between the sensor signals and emotions (such as happiness and so on) which are related to/associated with memories. Once the emotion suitable for capture status is detected, the camera may be triggered to capture. In addition, the system may identify objects of interest within the FOV of the user by correlating EMG/EEG data with gaze information.

According to additional aspects, a user may auto-capture similar content in a completely virtual reality environment, so that the content is not captured by a physical front facing camera, but by a virtual camera that is rendered by the scene. In this way, the user may save a highlight from their day in VR and/or MR. Additionally, users may save their captures in AR to capture a world view from the world facing camera, which may include the rendered virtual objects in the scene.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Access settings for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

The disclosed system(s) address a problem in traditional artificial reality environment control techniques tied to computer technology, namely, the technical problem of capturing a scene in a virtual environment. The disclosed system solves this technical problem by providing a solution also rooted in computer technology, namely, by providing for gaze-based camera auto-capture in virtual environments. The disclosed subject technology further provides improvements to the functioning of the computer itself because it improves processing and efficiency in cameras and/or AR/VR headsets for artificial reality environments.

### Example System Architecture

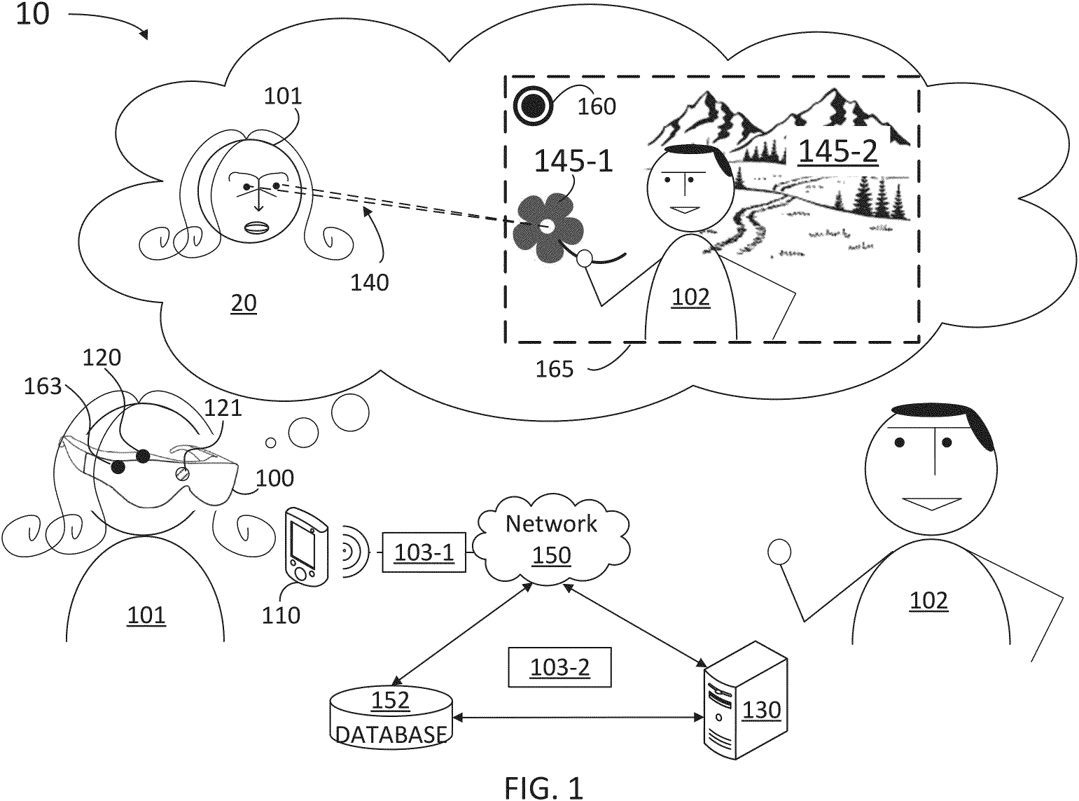

FIG. 1 illustrates a network architecture 10 where a user 101 of a VR/AR headset 100 performs a video capture of a mixed reality 20 triggered by a user gaze 140, according to some embodiments. Mixed reality 20 includes a real subject 102 provided by headset 100 in view-through mode, and virtual elements 145-1 (e.g., a flower) and 145-2 (e.g., the mountains), collectively referred to as “virtual elements 145.”

Headset 100 is paired with a mobile device 110, with a remote server 130, via a network 150. Server 130 may also communicate with a remote database 152 and transmit datasets 103-1, and 103-2 (hereinafter, collectively referred to as “datasets 103”) with one another. Datasets 103 may include images, text, audio, and computer-generated 3D renditions of mixed reality views in a virtual reality conversation. Headset 100 includes at least a camera 121 and an eye-tracking device 120 to detect the motion of the eyes of user 101 during an immersive reality conversation. Eye tracking device 120 can determine a gaze direction of user 101. In embodiments consistent with the present disclosure, each one of the devices illustrated in architecture 10 may include a memory storing instructions and one or more processors configured to execute the instructions to cause each device to participate, at least partially, in methods as disclosed herein. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

Mixed reality 20 includes a gaze 140 of user 101 focused on virtual object 145-1. In some embodiments, the object of interest of user 101 may be any one of virtual objects 145, or even real objects in mixed reality 20, such as subject 102, or a background object, virtual or real (e.g., a car, a train, a plane, another avatar, and the like). Upon detection of gaze 140, headset 100 may prompt user 101 to start a video recording of mixed reality 20. For this, headset 100 may include a frame 165 illustrating the portion of the field of view of camera 121 that will be recorded, and a recording indicator 160 which turns red or otherwise clearly indicates that the scene within frame 165 is being recorded. Recording indicator 160 may be visible by all participants in the immersive reality environment, and also may activate a physical recording indicator 163 in headset 100, visible by subject 102.

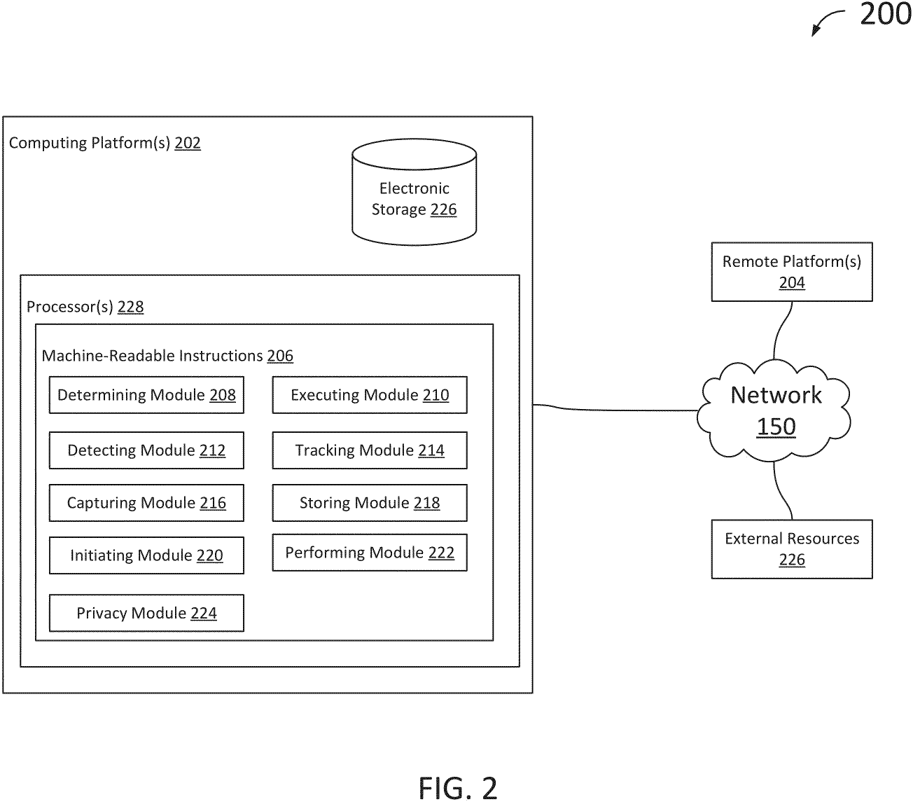

FIG. 2 illustrates a system 200 configured for gaze-based camera auto-capture, in accordance with one or more implementations. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via computing platform(s) 202 and/or remote platform(s) 204.

Computing platform(s) 202 may be configured by machine-readable instructions 206. Machine-readable instructions 206 may include one or more instruction modules. The instruction modules may include computer program modules. The instruction modules may include one or more of determining module 208, executing module 210, detecting module 212, tracking module 214, capturing module 216, storing module 218, initiating module 220, performing module 222, privacy module 224, and/or other instruction modules.

Determining module 208 may be configured to determine initiation of an auto-capture session by a user.

Executing module 210 may be configured to execute a gaze model based on the initiation.

Detecting module 212 may be configured to detect through the gaze model a gaze of the user.

Tracking module 214 may be configured to track the gaze of the user.

Capturing module 216 may be configured to capture a scene in a virtual environment based on the gaze of the user.

Storing module 218 may be configured to store the captured scene as a media file in storage.

Initiating module 220 may be configured to initiate a next level of a confirmation model to confirm that there is a meaningful object in the gaze of the user. The initiating module 220 may also be configured to initiate the capturing of the scene automatically.

Performing module 222 may be configured to perform auto-focus and/or auto-zoom for an object in the scene that the user is looking at.

Privacy module 224 is configured to handle a privacy wizard in a mixed reality application running in a VR/AR headset or a mobile device paired thereof (cf. headset 100 and mobile device 110), according to some embodiments.

In some implementations, computing platform(s) 202, remote platform(s) 204, and/or external resources 226 may be operatively linked via one or more electronic communication links. For example, such electronic communication links may be established, at least in part, via network 150 such as the Internet and/or other networks. It will be appreciated that this is not intended to be limiting, and that the scope of this disclosure includes implementations in which computing platform(s) 202, remote platform(s) 204, and/or external resources 226 may be operatively linked via some other communication media.

A given remote platform 204 may include one or more processors configured to execute computer program modules. The computer program modules may be configured to enable an expert or user associated with the given remote platform 204 to interface with system 200 and/or external resources 224, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, an augmented reality system (e.g., headset 100), a handheld controller, and/or other computing platforms.

External resources 224 may include sources of information outside of system 200, external entities participating with system 200, and/or other resources. In some implementations, some or all of the functionality attributed herein to external resources 224 may be provided by resources included in system 200.

Computing platform(s) 202 may include electronic storage 226, one or more processors 228, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 226 may comprise non-transitory storage media that electronically stores information. The electronic storage media of electronic storage 226 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 226 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 226 may include one or more virtual storage resources (e.g., cloud storage, a virtual private network, and/or other virtual storage resources). Electronic storage 226 may store software algorithms, information determined by processor(s) 228, information received from computing platform(s) 202, information received from remote platform(s) 204, and/or other information that enables computing platform(s) 202 to function as described herein.

Processor(s) 228 may be configured to provide information processing capabilities in computing platform(s) 202. As such, processor(s) 228 may include one or more of a digital processor, an analog processor, a digital circuit designed to process information, an analog circuit designed to process information, a state machine, and/or other mechanisms for electronically processing information. Although processor(s) 228 is shown in FIG. 2 as a single entity, this is for illustrative purposes only. In some implementations, processor(s) 228 may include a plurality of processing units. These processing units may be physically located within the same device, or processor(s) 228 may represent processing functionality of a plurality of devices operating in coordination. Processor(s) 228 may be configured to execute modules 208, 210, 212, 214, 216, 218, 220, 222, 224 and/or 226, and/or other modules. Processor(s) 228 may be configured to execute modules 208, 210, 212, 214, 216, 218, 220, 222, 224 and/or 226, and/or other modules by software; hardware; firmware; some combination of software, hardware, and/or firmware; and/or other mechanisms for configuring processing capabilities on processor(s) 228. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, and/or 226 are illustrated in FIG. 2 as being implemented within a single processing unit, in implementations in which processor(s) 228 includes multiple processing units, one or more of modules 208, 210, 212, 214, 216, 218, 220, 222, 224 and/or 226 may be implemented remotely from the other modules. The description of the functionality provided by the different modules 208, 210, 212, 214, 216, 218, 220, 222, 224 and/or 226 described below is for illustrative purposes, and is not intended to be limiting, as any of modules 208, 210, 212, 214, 216, 218, 220, 222, 224 and/or 226 may provide more or less functionality than is described. For example, one or more of modules 208, 210, 212, 214, 216, 218, 220, 222, 224 and/or 226 may be eliminated, and some or all of its functionality may be provided by other ones of modules 208, 210, 212, 214, 216, 218, 220, 222, 224 and/or 226. As another example, processor(s) 228 may be configured to execute one or more additional modules that may perform some or all of the functionality attributed below to one of modules 208, 210, 212, 214, 216, 218, 220, 222, 224 and/or 226.

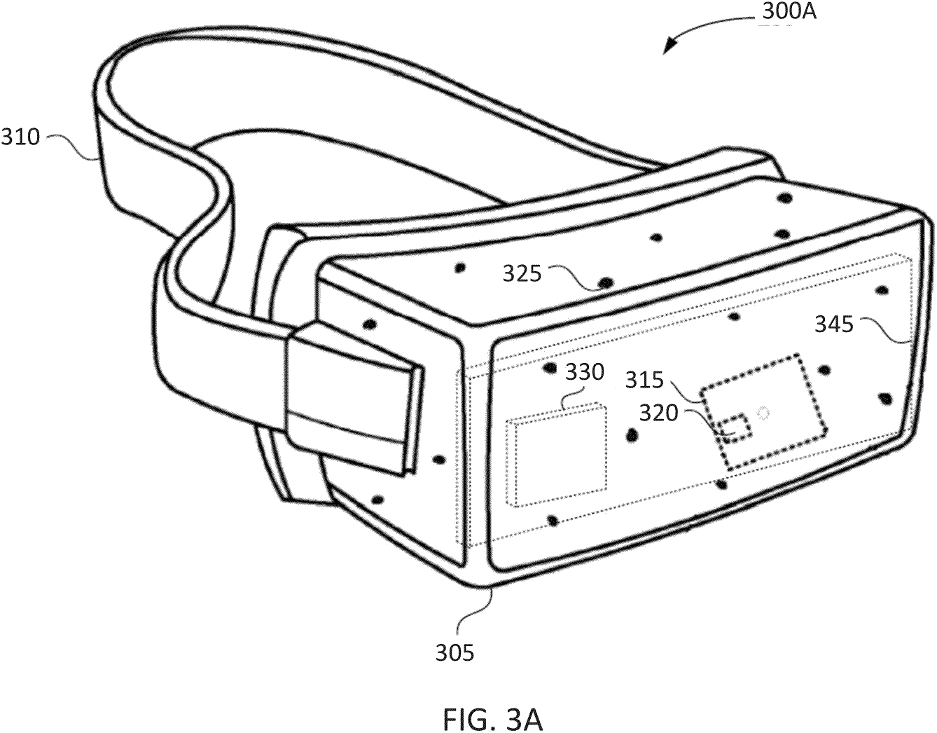

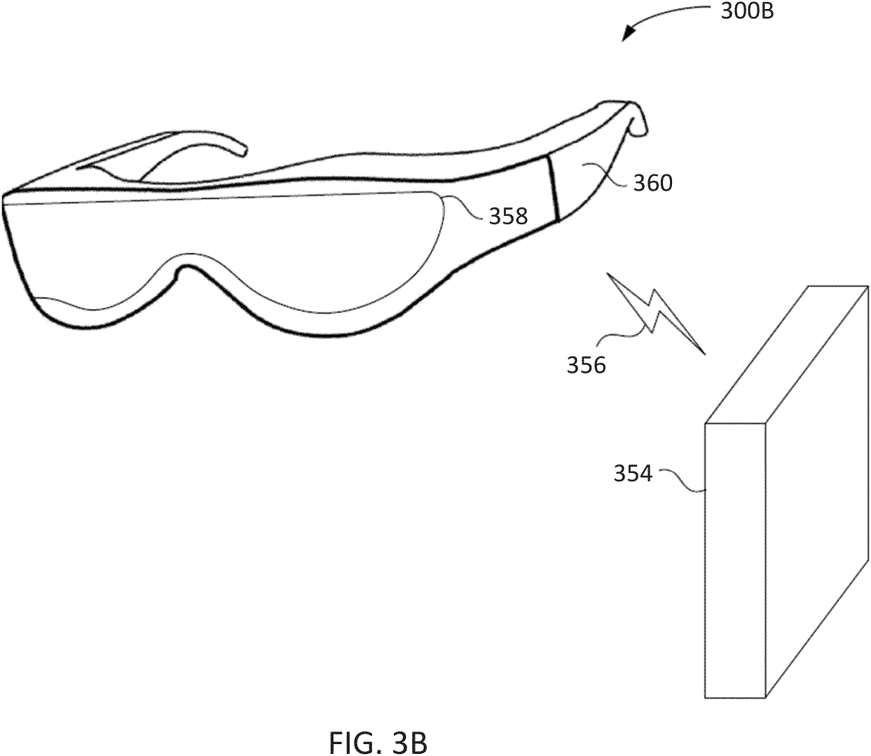

FIGS. 3A and 3B illustrate partial views of headsets 300A and 300B, hereinafter collectively referred to as “headsets 300,” according to some embodiments.

Headset 300A includes a front rigid body 305 and a band 310. The front rigid body 305 includes one or more electronic display elements of an electronic display 345, an inertial motion unit (IMU) 315, one or more position sensors 320, locators 325, and one or more compute units 330. The position sensors 320, the IMU 315, and compute units 330 may be internal to headset 300A and may not be visible to the user. In various implementations, the IMU 315, position sensors 320, and locators 325 can track movement and location of headset 300A in the real world and in a virtual environment in three degrees of freedom (3DoF) or six degrees of freedom (6DoF). For example, the locators 325 can emit infrared light beams which create light points on real objects around headset 100. As another example, the IMU 315 can include, e.g., one or more accelerometers, gyroscopes, magnetometers, other non-camera-based position, force, or orientation sensors, or combinations thereof. One or more cameras (not shown) integrated with headset 300A can detect the light points. Compute units 330 in headset 300A can use the detected light points to extrapolate position and movement of headset 300A as well as to identify the shape and position of the real objects surrounding headset 300A.

The electronic display 345 can be integrated with the front rigid body 305 and can provide image light to a user as dictated by the compute units 330. In various embodiments, the electronic display 345 can be a single electronic display or multiple electronic displays (e.g., a display for each user eye). Examples of the electronic display 345 include: a liquid crystal display (LCD), an organic light-emitting diode (OLED) display, an active-matrix organic light-emitting diode display (AMOLED), a display including one or more quantum dot light-emitting diode (QOLED) subpixels, a projector unit (e.g., microLED, LASER, etc.), some other display, or some combination thereof.

In some implementations, headset 300A can be coupled to a core processing component such as a personal computer (PC) (not shown) and/or one or more external sensors (not shown). The external sensors can monitor headset 300A (e.g., via light emitted from headset 300A) which the PC can use, in combination with output from the IMU 315 and position sensors 320, to determine the location and movement of headset 300A.

Headset 300B and core processing component 354 can communicate via a wireless connection (e.g., a 60 GHz link) as indicated by link 356. In other implementations, headset 300B includes a headset only, without an external compute device or includes other wired or wireless connections between headset 300B and core processing component 354. Headset 300B includes a pass-through display 358 and a frame 360. Frame 360 can house various electronic components (not shown) such as light projectors (e.g., LASERs, LEDs, etc.), cameras, eye-tracking sensors, MEMS components, networking components, etc.

The projectors can be coupled to the pass-through display 358, e.g., via optical elements, to display media to a user. The optical elements can include one or more waveguide assemblies, reflectors, lenses, mirrors, collimators, gratings, etc., for directing light from the projectors to a user’s eye. Image data can be transmitted from the core processing component 354 via link 356 to headset 300B. Controllers in headset 300B can convert the image data into light pulses from the projectors, which can be transmitted via the optical elements as output light to the user’s eye. The output light can mix with light that passes through the display 358, allowing the output light to present virtual objects that appear as if they exist in the real world.

Headset 300B can also include motion and position tracking units, cameras, light sources, etc., which allow headset 300B to, e.g., track itself in 3DoF or 6DoF, track portions of the user (e.g., hands, feet, head, or other body parts), map virtual objects to appear as stationary as headset 300B moves, and have virtual objects react to gestures and other real-world objects.

According to aspects, headsets 300 may be configured to perform gaze-based camera auto-capture, as described herein.

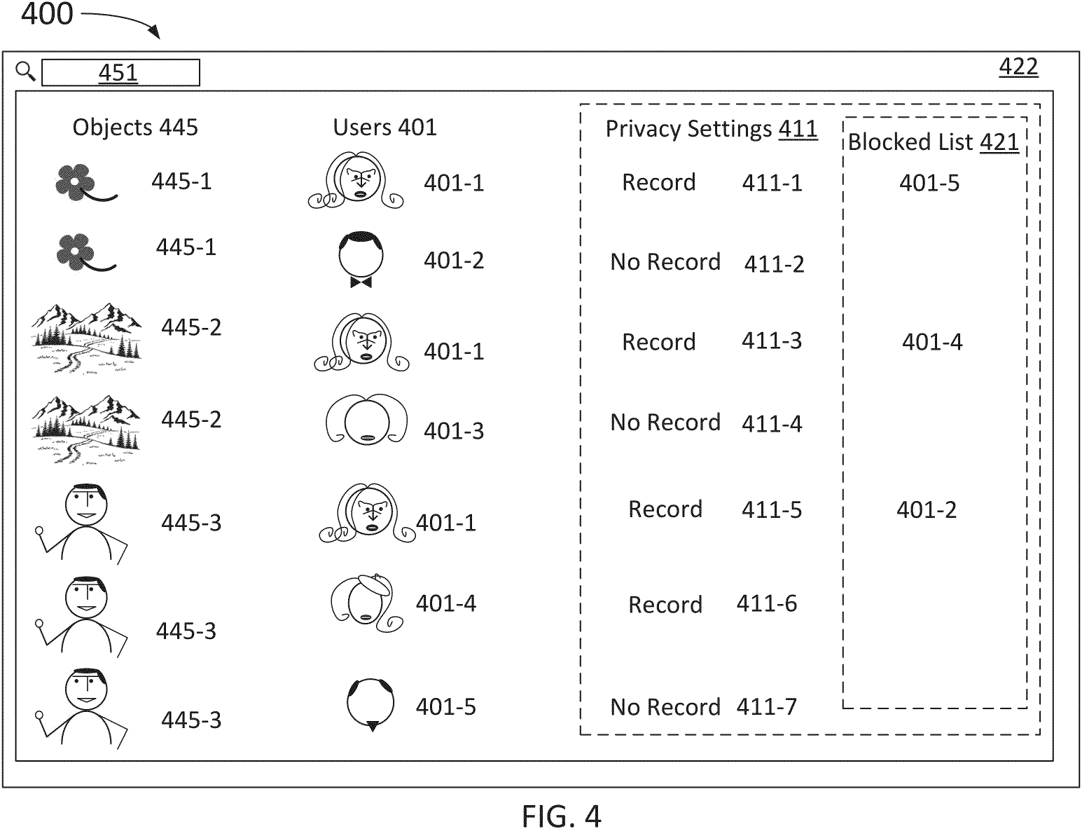

FIG. 4 illustrates screenshots of a privacy wizard 400 from a social-network application 422 running in a headset (cf. headsets 100 or 300), according to some embodiments. In some embodiments, privacy wizard 400 is displayed within a webpage, a module, one or more dialog boxes, or any other suitable interface to assist the headset user in specifying one or more privacy settings 411-1, 411-2, 411-3, 411-4, 411-5, 411-6, and 411-7 (hereinafter, collectively referred to as “privacy settings 411”) associated with objects 445-1, 445-2, and 445-3 (real or virtual, hereinafter, collectively referred to as “objects 445”) and users 401-1, 401-2, 401-3, 401-4, and 401-5 (hereinafter, collectively referred to as “users 401”) in a mixed reality environment (cf. mixed reality 20). As can be seen, each of privacy settings 411 are associated with a specific combination of one of objects 445 and one of users 401 (e.g., the same user 401 may have different privacy settings 411 for different objects 445, and the same object 445 may have different privacy settings 411 for different users 401).

Privacy wizard 400 may display instructions, suitable privacy-related information, current privacy settings 411, one or more input fields for accepting one or more inputs from the first user specifying a change or confirmation of privacy settings 411, or any suitable combination thereof. The dashboard functionality of wizard 400 may be displayed to a user 401 at any appropriate time (e.g., following an input from the user summoning the dashboard functionality, following the occurrence of a particular event or trigger action). The dashboard functionality may allow users 401 to modify one or more of the first user’s current privacy settings at any time, in any suitable manner (e.g., redirecting the first user to the privacy wizard). A personalized dashboard for each user 401 may include only the objects 445 and the privacy settings 411 for that particular user.

Privacy settings 411 for an object may specify a “blocked list” 421 of users 401 or other entities that should not be allowed to access certain information associated with the object. In particular embodiments, blocked list 421 may include third-party entities. Blocked list 421 may specify one or more users 401 or entities for which an object 445 is not visible. As an example and not by way of limitation, a user 401-1 may specify a set of users (401-5) who may not access photo albums associated with the user, thus excluding those users from accessing the photo albums (while also possibly allowing certain users not within the specified set of users to access the photo albums).

In particular embodiments, one or more servers may be authorization/privacy servers for enforcing privacy settings 411. In response to a request from a user 401 (or other entity) for a particular object 445 stored in a data store, the social-networking system may send a request to the data store for the object. The request may identify the user 401 associated with the request and the object 445 may be sent only to user 401 (or a client system of the user) if the authorization server determines that user 401 is authorized to access the object based on privacy settings 411 associated with object 445. If the requesting user 401 is not authorized to access object 445, the authorization server may prevent the requested object 445 from being retrieved from the data store or may prevent the requested object 445 from being sent to user 401. In a search query 451, an object 445 may be provided as a search result only if the querying user is authorized to access the object, e.g., if the privacy settings for the object allow it to be surfaced to, discovered by, or otherwise visible to the querying user. In particular embodiments, an object 445 may represent content that is visible to a user through a newsfeed of the user. As an example, and not by way of limitation, one or more objects 445 may be visible to a user’s “Trending” page. In particular embodiments, an object 445 may correspond to a particular user 401. Object 445 may be content associated with user 401, or may be the particular user’s account or information stored on the social-networking system, or other computing system. As an example and not by way of limitation, a first user 401 may view one or more second users 401 of an online social network through a “People You May Know” function of the online social network, or by viewing a list of friends of the first user. As an example and not by way of limitation, a first user 401-1 may specify that they do not wish to see objects 445 associated with a particular second user 401-2 in their newsfeed or friends list. If privacy settings 411 for an object 445 do not allow it to be surfaced to, discovered by, or visible to a user 401-1, the object may be excluded from the search results in search query 451 for user 401-1. Although this disclosure describes enforcing privacy settings 411 in a particular manner, this disclosure contemplates enforcing privacy settings in any suitable manner.

In particular embodiments, different objects 445 of the same type associated with a user 401 may have different privacy settings 411. Different types of objects 445 associated with a user 401 may have different types of privacy settings 411. As an example and not by way of limitation, user 401-1 may specify that the first user’s status updates are public, but any images shared by user 401-1 are visible only to the first user’s friends on the online social network (e.g., users 401-3 and 401-4). As another example and not by way of limitation, user 401-1 may specify different privacy settings for different types of entities, such as individual users, friends-of-friends, followers, user groups, or corporate entities. As another example and not by way of limitation, user 401-1 may specify a group of users that may view videos posted by first user 401-1, while keeping the videos from being visible to the first user’s employer. In particular embodiments, different privacy settings 411 may be provided for different user groups or user demographics. As an example and not by way of limitation, a first user 401-1 may specify that other users 401 who attend the same university as first user 401-1 may view the first user’s pictures, but that other users 401 who are family members of the first user may not view those same pictures.

In particular embodiments, the social-networking system may provide one or more default privacy settings 411 for each object 445 of a particular object-type. A privacy setting 411 for an object 445 that is set to a default may be changed by a user 401 associated with that object. As an example and not by way of limitation, all images posted by user 401-1 may have a default privacy setting 411-1 of being visible only to friends of user 401-1 and, for a particular image 445-2, user 401-1 may change privacy settings 411-4 for the image to be visible to friends and friends-of-friends (e.g., user 401-3).

In particular embodiments, privacy settings 411 may allow user 401-1 to specify (e.g., by opting out, by not opting in) whether the social-networking system may receive, collect, log, or store particular objects or information associated with user 401-1 for any purpose. In particular embodiments, privacy settings 411 may allow user 401-1 to specify whether particular applications or processes may access, store, or use particular objects 445 or information associated with user 401-1. Privacy settings 411 may allow user 401-1 to opt in or opt out of having objects 445 or information accessed, stored, or used by specific applications or processes. The social-networking system may access such information in order to provide a particular function or service to user 401-1, without the social-networking system having access to that information for any other purposes. Before accessing, storing, or using such objects or information, the social-networking system may prompt user 401-1 to provide privacy settings 411 specifying which applications or processes, if any, may access, store, or use an object 445 or information prior to allowing any such action. As an example and not by way of limitation, user 401-1 may transmit a message to a second user 401-2 via an application related to the online social network (e.g., a messaging app), and may specify privacy settings 411 that such messages should not be stored by the social-networking system.

In particular embodiments, users 401 may specify whether particular types of objects 445 or users may be accessed, stored, or used by the social-networking system. As an example and not by way of limitation, user 401-1 may specify that images sent through the social-networking system may not be stored by the social-networking system. As another example and not by way of limitation, user 401-1 may specify that messages sent from the first user to a particular second user may not be stored by the social-networking system. As yet another example and not by way of limitation, user 401-1 may specify that objects 445 sent via application 422 may be saved by the social-networking system.

In particular embodiments, privacy settings 411 may allow user 401-1 to specify whether particular objects 445 or information associated with user 401-1 may be accessed from particular client systems or third-party systems. The privacy settings may allow user 401-1 to opt in or opt out of having objects 445 or information accessed from a particular device (e.g., the phone book on a user’s smart phone), from a particular application (e.g., a messaging app), or from a particular system (e.g., an email server). The social-networking system may provide default privacy settings with respect to each device, system, or application, and/or the first user may be prompted to specify a privacy setting 411 for each context. As an example and not by way of limitation, user 401-1 may utilize a location-services feature of the social-networking system to provide recommendations for restaurants or other places in proximity to user 401-1. A user’s default privacy settings may specify that the social-networking system may use location information provided from a client device of user 401-1 to provide the location-based services, but that the social-networking system may not store the location information of user 401-1 or provide it to any third-party system. User 401-1 may then update privacy settings 411 to allow location information to be used by a third-party image-sharing application in order to geo-tag photos.

In particular embodiments, privacy settings 411 may allow users 401 to specify one or more geographic locations from which objects can be accessed. Access or denial of access to objects 445 may depend on the geographic location of the user 401 who is attempting to access objects 445. As an example and not by way of limitation, a user 401-1 may share an object 445-2 and specify that only users 401 in the same city may access or view object 445-2. As another example and not by way of limitation, user 401-1 may share object 445-2 and specify that object 445-2 is visible to user 401-3 only while user 401-1 is in a particular location. If user 401-1 leaves the particular location, object 445-2 may no longer be visible to user 401-3. As another example and not by way of limitation, user 401-1 may specify that object 445-2 is visible only to users 401 within a threshold distance from user 401-1. If user 401-1 subsequently changes location, the original users 401 with access to object 445-2 may lose access, while a new group of users 401 may gain access as they come within the threshold distance of user 401-1.

In particular embodiments, changes to privacy settings 411 may take effect retroactively, affecting the visibility of objects 445 and content shared prior to the change. As an example and not by way of limitation, user 401-1 may share object 445-1 and specify that it be public to all other users 401. At a later time, user 401-1 may specify that object 445-1 be shared only to a selected group of users 401. In particular embodiments, the change in privacy settings 411 may take effect only going forward. Continuing the example above, if user 401-1 changes privacy settings 411 and then shares object 445-2, this may be visible only to the selected group of users 401, but object 445-1 may remain visible to all users. In particular embodiments, in response to an action from user 401-1 to change privacy settings 411, the social-networking system may further prompt user 401-1 to indicate whether they want to apply the changes to privacy settings 411 retroactively. In particular embodiments, a user change to privacy settings 411 may be a one-off change specific to one object 445. In particular embodiments, a user change to privacy may be a global change for all objects 445 associated with user 401.

In particular embodiments, the social-networking system may determine that user 401-1 may want to change one or more privacy settings 411 in response to a trigger action. The trigger action may be any suitable action on the online social network. As an example and not by way of limitation, a trigger action may be a change in the relationship between user 401-1 and user 401-2 (e.g., “un-friending” a user, changing the relationship status between the users 401-1 and 401-2). In particular embodiments, upon determining that a trigger action has occurred, the social-networking system may prompt user 401-1 to change the privacy settings regarding the visibility of objects 445 associated with user 401-1. The prompt may redirect user 401-1 to a workflow process for editing privacy settings 411 with respect to one or more entities associated with the trigger action. Privacy settings 411 associated with user 401-1 may be changed only in response to an explicit input from user 401-1, and may not be changed without the approval of user 401-1. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from user 401-1 to change the privacy settings based on any of the methods described herein, or to keep the existing privacy settings.

In particular embodiments, user 401-1 may need to provide verification of privacy setting 411-1 before allowing user 401-1 to perform particular actions on the online social network, or to provide verification before changing privacy setting 411-1. When performing particular actions or changing privacy setting 411-1, a prompt may be presented to user 401-1 to remind user 401-1 of his or her current privacy settings 411 and to verify privacy setting 411-1. Furthermore, user 401-1 may need to provide confirmation, double-confirmation, authentication, or other suitable types of verification before proceeding with the particular action, and the action may not be complete until such verification is provided. As an example and not by way of limitation, a privacy setting 411-1 may indicate that a person’s relationship status is visible to all users 401 (i.e., “public”). However, if user 401-1 changes his or her relationship status, the social-networking system may determine that such action may be sensitive and may prompt user 401-1 to confirm that his or her relationship status should remain public before proceeding. As another example and not by way of limitation, a privacy setting 411 may specify that the posts of user 401-1 are visible only to friends of the user (e.g., users 401-3 and 401-4). However, if user 401-1 changes privacy settings 411 for his or her posts to being public, the social-networking system may prompt user 401-1 with a reminder of the current privacy settings 411 being visible only to friends, and a warning that this change will make all of the past posts visible to the public. User 401-1 may then be required to provide a second verification, input authentication credentials, or provide other types of verification before proceeding with the change in privacy settings. In particular embodiments, user 401-1 may need to provide verification of privacy setting 411-1 on a periodic basis. A prompt or reminder may be periodically sent to user 401-1 based either on time elapsed or a number of user actions. As an example and not by way of limitation, the social-networking system may send a reminder to user 401-1 to confirm his or her privacy settings 411 every six months or after every ten posts of objects 445. In particular embodiments, privacy settings 411 may also allow users 401 to control access to objects 445 or information on a per-request basis. As an example and not by way of limitation, the social-networking system may notify user 401-1 whenever a third-party system attempts to access information associated with them, and request user 401-1 to provide verification that access should be allowed before proceeding.

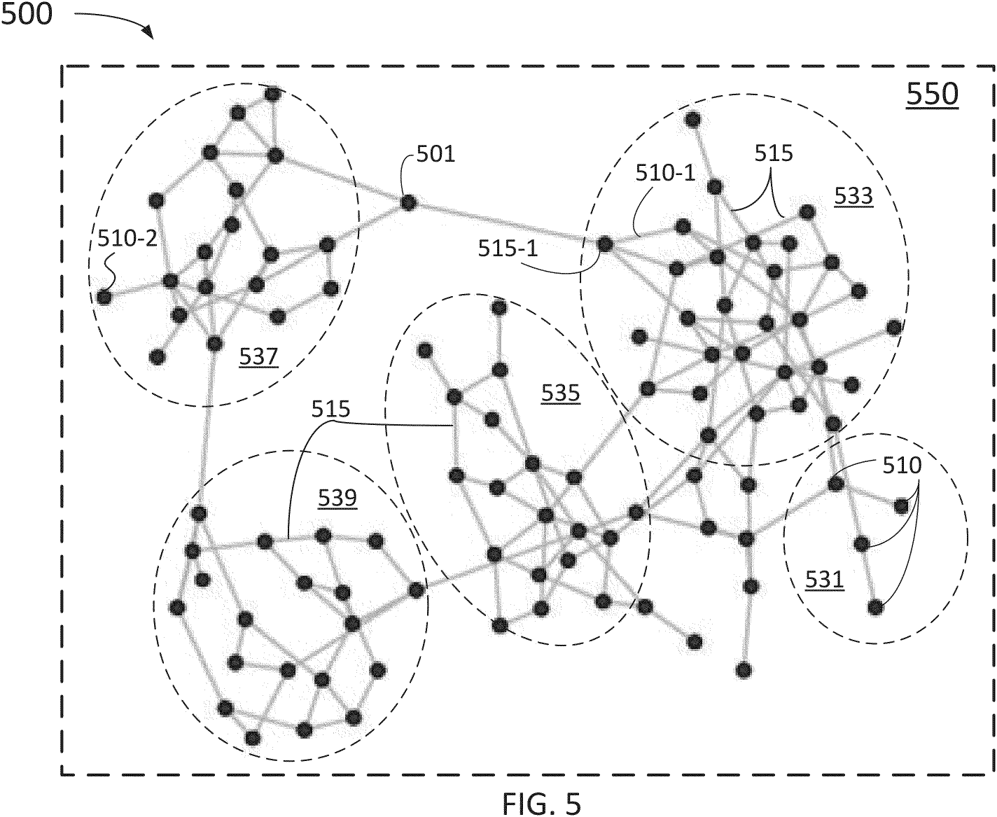

FIG. 5 illustrates a social graph 550 used by a social network 500 to manage privacy settings in messaging and immersive reality applications (cf. privacy settings 411), according to some embodiments. Social graph 550 includes multiple nodes 510 connected pairwise through multiple edges 515 (e.g., one edge 515 connects two nodes 510). Nodes 510 correspond to users of social network 500, and may be people, institutions, or other social entities that group together multiple people. In some embodiments, nodes 510 may be “concept” nodes, associated with some entity (e.g., a national park having media files -pictures, movies, maps, and the like- associated with it).

Privacy settings as disclosed herein may be applied to a particular edge 515 connecting two nodes 510 and may control whether the relationship between the two entities corresponding to the nodes 510 is visible to other users of the online social network. Similarly, privacy settings applied to a particular node 510 may control whether the node is visible to other users of social network 500. As an example and not by way of limitation, a node 501 may be a user sharing an object with selected portions of social network 500 (e.g., user 401-1 and object 445-1). The object may be associated with a concept node 510-1 connected to node 501 by an edge 515-1. The user in user node 501 may specify privacy settings that apply to edge 515-1, or may specify privacy settings that apply to all edges 515 connecting to concept node 510-1. Node 501 may include specific privacy settings with respect to all objects associated with node 501 or to objects having a particular type or that have a specific relation to node 501 (e.g., friends of the user in node 501 and/or users tagged in images associated with the user in node 501).

Node 501 may specify any suitable granularity of permitted access or denial of access via privacy settings as disclosed herein. As an example and not by way of limitation, access or denial of access may be specified for particular users, e.g., only me -node 501-, my roommates -531-, my boss -510-2), users within a particular degree-of-separation (e.g., friends -533-, friends-of-friends -535), user groups (e.g., the gaming club, my family), user networks 537 (e.g., employees of particular employers, coworkers, students or alumni of particular university), all users (“public”), no users (“private”), users of third-party systems, particular applications, e.g., third-party applications, external websites, and the like, other suitable entities, or any suitable combination thereof -539-.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

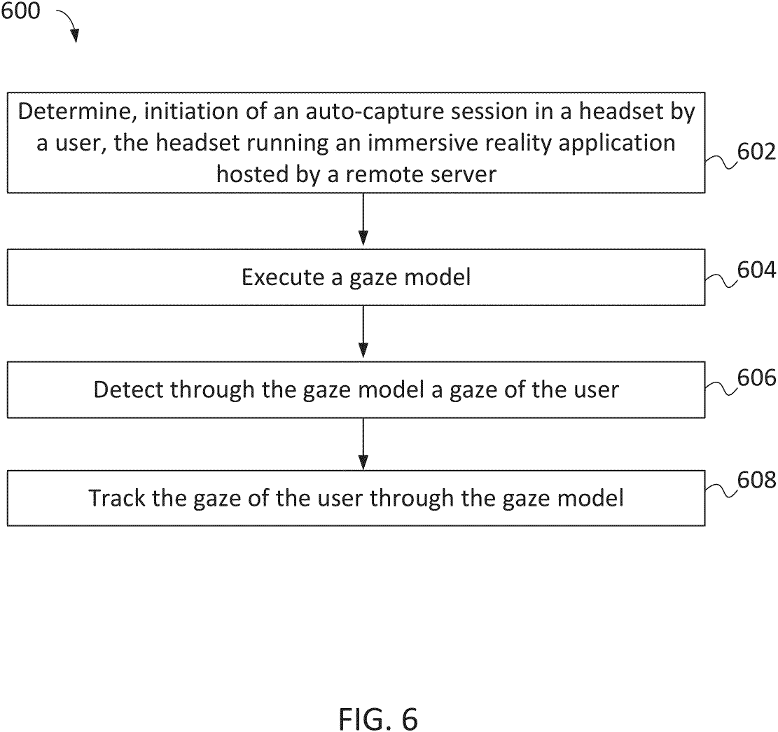

FIG. 6 illustrates a flow chart of a process 600 for gaze-based camera auto-capture, according to certain aspects of the disclosure. For explanatory purposes, process 600 is described herein with reference to FIGS. 1, 2, 3A-3B, 4, and 5. For explanatory purposes, some blocks of process 600 are described herein as occurring in series, or linearly. However, multiple blocks in process 600 may occur in parallel. In addition, the blocks of process 600 need not be performed in the order shown and/or one or more of the blocks of process 600 need not be performed.

At step 602, it is determined that a user has initiated an auto-capture session in a headset. The headset may be running an immersive reality application hosted by a remote server, as disclosed herein.

At step 604, a gaze model is executed based on the initiated auto-capture session. In some embodiments, step 604 includes detecting that the gaze of the user is longer than a pre-selected threshold.

At step 606, the gaze model detects a gaze of the user. In some embodiments, step 606 includes initiating a next level of a confirmation model to confirm that there is a meaningful object in the gaze of the user.

At step 608, the gaze of the user is tracked through the gaze model. In some embodiments, step 608 includes identifying an object that is a target in the gaze of the user. In some embodiments, step 608 performing auto-focusing and/or auto-zooming for an object that is a target in the gaze of the user.

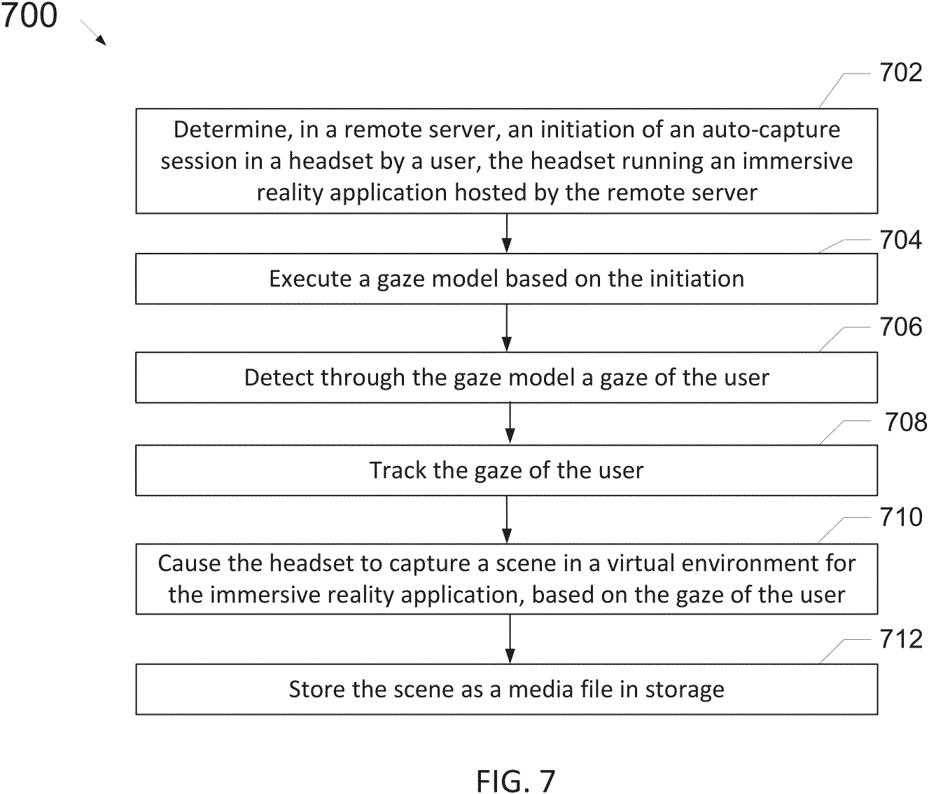

FIG. 7 illustrates an example flow diagram (e.g., process 700) for gaze-based camera auto-capture, according to certain aspects of the disclosure. For explanatory purposes, the example process 700 is described herein with reference to FIGS. 1, 2, 3A-3B, 4, and 5. Further for explanatory purposes, the steps of the example process 700 are described herein as occurring in serial, or linearly. However, multiple instances of the example process 700 may occur in parallel.

At step 702, process 700 may include determining, in a remote server, initiation of an auto-capture session in a headset by a user (e.g., via determining module 208). The headset running an immersive reality application hosted by the remote server.

At step 704, process 700 may include executing a gaze model based (e.g., through headsets 100 and 300, and/or AR/smart glasses) on the initiation (e.g., via executing module 210).

At step 706, process 700 may include detecting through the gaze model a gaze of the user (e.g., via detecting module 212).

At step 708, process 700 may include tracking the gaze of the user (e.g., via tracking module 214).

At step 710, process 700 may include capturing a scene in a virtual environment based on the gaze of the user (e.g., via capturing module 216). In some embodiments, step 710 includes identifying an object in the scene and verifying a privacy setting of the object in a user account of the immersive reality application. In some embodiments, step 710 includes identifying a person in the scene and verifying a privacy setting of the person in a social network that includes the person and the user. In some embodiments, step 710 includes identifying an object in the scene and verifying a privacy setting for the object in a social graph that has a node for the user.

At step 712, process 700 may include storing the captured scene as a media file in a storage medium (e.g., via storing module 218). In some embodiments, step 712 may include storing a picture, a video, and an audio file in the storage medium.

According to an aspect, the gaze model is configured to detect that the gaze of the user is longer than a threshold.

According to an aspect, the tracking tracks what the user is looking at during capturing.

According to an aspect, the media file comprises an image or a video.

According to an aspect, process 700 may further include, in response to determining that the gaze is longer than the threshold, initiating a next level of a confirmation model to confirm that there is a meaningful object in the gaze of the user.

According to an aspect, process 700 may further include initiating the capturing of the scene automatically.

According to an aspect, process 700 may further include performing auto-focusing and/or auto-zooming for an object in the scene that the user is looking at.

### Hardware Overview

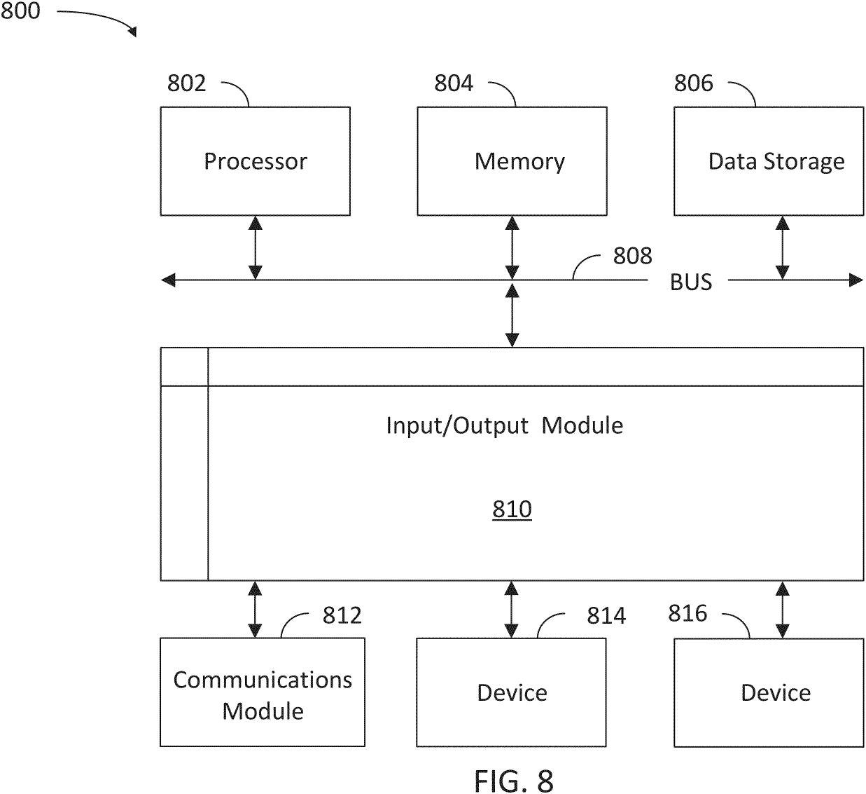

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

Computer system 800 (e.g., server and/or client) includes a bus 808 or other communication mechanism for communicating information, and a processor 802 coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as an LCD (liquid crystal display) monitor, a waveguide-based and other AR displays, for displaying information to the user.

According to one aspect of the present disclosure, the above-described gaming systems can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in the main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires that comprise bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 800 reads game data and provides a game, information may be read from the game data and stored in a memory device, such as the memory 804. Additionally, data from the memory 804 servers accessed via a network the bus 808, or the data storage 806 may be read and loaded into the memory 804. Although data is described as being found in the memory 804, it will be understood that data does not have to be stored in the memory 804 and may be stored in other memory accessible to the processor 802 or distributed among several media, such as the data storage 806.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for capturing a scene in a virtual environment, comprising:
determining initiation of an auto-capture session in a headset by a user, the headset running an immersive reality application hosted by a remote server;
executing a gaze model based on the initiation;
detecting through the gaze model a gaze of the user;
tracking the gaze of the user;
capturing a scene in a virtual environment based on the gaze of the user; and
storing the scene as a media file in storage.

2. The computer-implemented method of claim 1, wherein executing the gaze model comprises detecting that the gaze of the user is longer than a pre-selected threshold.

3. The computer-implemented method of claim 2, further comprising initiating a next level of a confirmation model to confirm that there is a meaningful object in the gaze of the user.

4. The computer-implemented method of claim 3, further comprising automatically initiating the capturing of the scene.

5. The computer-implemented method of claim 1, wherein tracking the gaze of the user comprises identifying an object that is a target in the gaze of the user.

6. The computer-implemented method of claim 1, wherein capturing the scene in the virtual environment comprises identifying an object in the scene and verifying a privacy setting of the object in a user account.

7. The computer-implemented method of claim 1, further comprising performing auto-focusing and/or auto-zooming for an object that is a target in the gaze of the user.

8. A system configured for relaying a message through a social network, the system comprising:
a one or more processors configured by machine-readable instructions to cause the system to:
determine an initiation of an auto-capture session by a user of a headset, the user being a subscriber of the social network;
execute a gaze model based on the initiation;
detect through the gaze model a gaze of the user;
track the gaze of the user;
capture a scene in a virtual environment based on the gaze of the user; and
store the scene as a media file in storage.

9. The system of claim 8, wherein the one or more processors further cause the system to detect that the gaze of the user is longer than a threshold and to confirm that there is a meaningful object in the gaze of the user.

10. The system of claim 8, wherein the one or more processors further cause the system to automatically initiate a capture of the scene.

11. The system of claim 8, wherein the one or more processors further cause the system to track an object in the gaze of the user.

12. The system of claim 8, wherein the one or more processors further cause the system to identify an object in the scene and to verify a privacy setting of the object in a user account.

13. The system of claim 8, wherein the one or more processors further cause the system to identify a person in the scene and verifying a content setting of the person in the social network.

14. The system of claim 8, wherein the one or more processors further cause the system to perform an auto-focus and/or an auto-zoom for an object that is a target in the gaze of the user.

15. A non-transient, computer-readable storage medium having instructions which, when executed by a processor, cause a computer to:
determine initiation of an auto-capture session in a headset by a user, the headset running an immersive reality application hosted by a remote server;
execute a gaze model based on the initiation;
detect through the gaze model a gaze of the user;
track the gaze of the user;
capture a scene in a virtual environment based on the gaze of the user; and
store the scene as a media file in storage.

16. The non-transient, computer-readable storage medium of claim 15, wherein to execute the gaze model, the processor further executes instructions to cause the computer to detect that the gaze of the user is longer than a threshold.

17. The non-transient, computer-readable storage medium of claim 15, wherein the processor further executes instructions to cause the computer to verify that there is a meaningful object in the gaze of the user.

18. The non-transient, computer-readable storage medium of claim 15, wherein the processor further executes instructions to cause the computer to automatically initiate the capture of the scene automatically.

19. The non-transient, computer-readable storage medium of claim 15, wherein the processor further executes instructions to cause the computer to track an object that is a target in the gaze of the user.

20. The non-transient, computer-readable storage medium of claim 15, wherein to capture the scene in the virtual environment, the processor further executes instructions to cause the computer to identify an object in the scene and verifying a privacy setting of the object in a user account.
